(19) United States
(12) Patent Application Publication
(10) Pub. No.: US 2016/0091520 A1
(43) Pub. Date: Mar. 31, 2016

(54) Automatic Apparatus of Screening Disease/Cancer in Vitro

(71) Applicant: Institute of Nuclear Energy Research, Atomic Energy Council, Executive Yuan, R.O.C., Taoyuan County (TW)

(72) Inventors: Tsung-Chih Hsieh, Taoyuan County (TW); Kuan-Yin Chen, Taoyuan County (TW); Chun-Ying Chen, Taoyuan County (TW)

(21) Appl. No.: 14/501,405

(22) Filed: Sep. 30, 2014

(51) Int. Cl. G01N 35/10; G01N 35/00

(52) U.S. Cl. CPC G01N 35/1081; G01N 35/1002; G01N 35/0099; G01N 2035/00554; G01N 2035/00346

(57) ABSTRACT

An automatic apparatus is provided for screening disease/cancer in vitro. The apparatus comprises a filling device; a gripping device at a side of the filling device; a carrying platform correspondingly set under the filling device and the gripping device; a containing device on the carrying platform; at least two receiving slots on the carrying platform; a placing device on the carrying platform; a shaking device on the carrying platform; and a detecting device on the carrying platform. Thus, the apparatus is provided for molecular biological researches, biochemical examinations, radioimmunoassay and drug developments with reduced human labor, saved operating time, avoided experimental errors and enhanced experimental accuracy and efficiency.

### TECHNICAL FIELD OF THE INVENTION

The present invention relates to screening disease/cancer; more particularly, relates to an automatic apparatus of screening disease/cancer for molecular biological researches, biochemical examinations, radioimmunoassay and drug developments with reduced human labor, saved operating time, avoided experimental errors and enhanced experimental accuracy and efficiency.

### DESCRIPTION OF THE RELATED ART

Generally, molecular biological researches, biochemical detections, radioimmunoassay and drug developments are carried out by way of related operations of manual labor.

However, concerning conventional manual operations, not only operating time and human burden of laboratory personnel are increased; but also experimental errors may happen because of the manual operations, which may further affect accuracy and efficiency of experiments.

Hence, the prior art does not fulfill all users' requests on actual use.

### SUMMARY OF THE INVENTION

The main purpose of the present invention is to provide an automatic apparatus of screening disease/cancer for molecular biological researches, biochemical examinations, radioimmunoassay and drug developments with reduced human labor, saved operating time, avoided experimental errors and enhanced experimental accuracy and efficiency.

To achieve the above purpose, the present invention is an automatic apparatus of screening disease/cancer in vitro, comprising a filling device; a gripping device at a side of the filling device; a carrying platform correspondingly set under the filling device and the gripping device; a containing device on the carrying platform; at least two receiving slots on the carrying platform; a placing device on the carrying platform; a shaking device on the carrying platform; and a detecting device on the carrying platform. Accordingly, a novel automatic apparatus of screening disease/cancer in vitro is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the perspective view showing the preferred embodiment according to the present invention; and

FIG. 2 is the top-down view showing the carrying platform.

### DESCRIPTION OF THE PREFERRED EMBODIMENT

The following description of the preferred embodiment is provided to understand the features and the structures of the present invention.

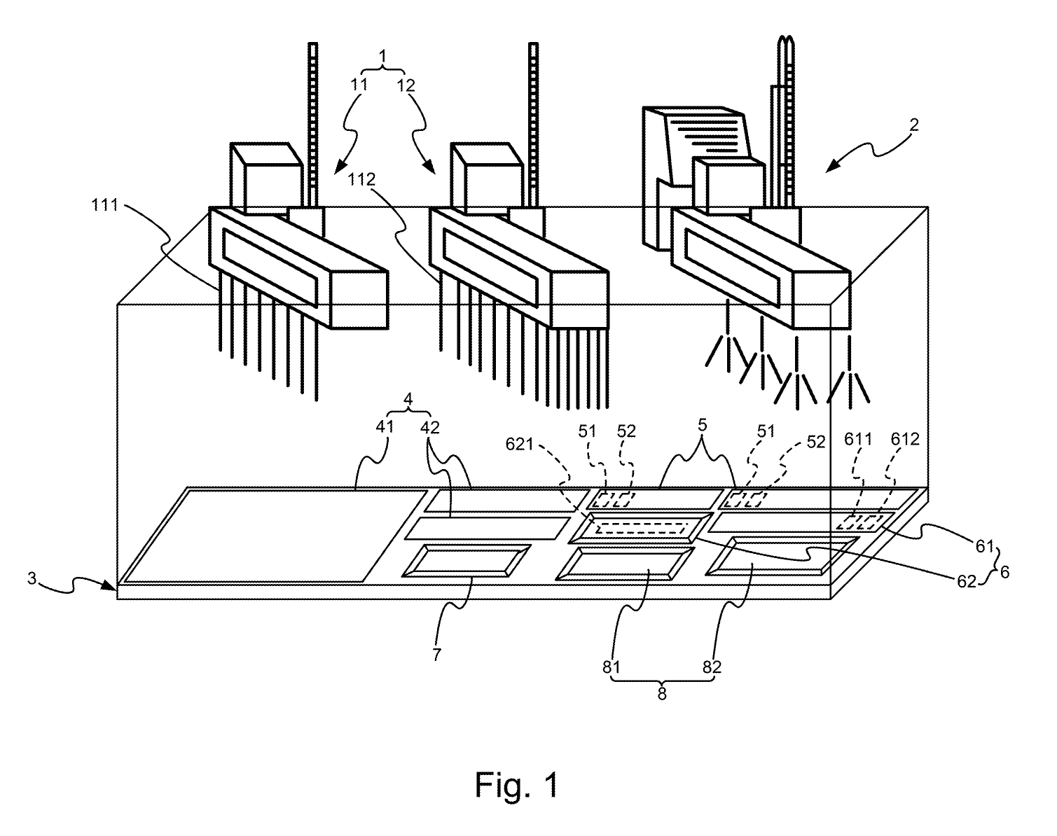

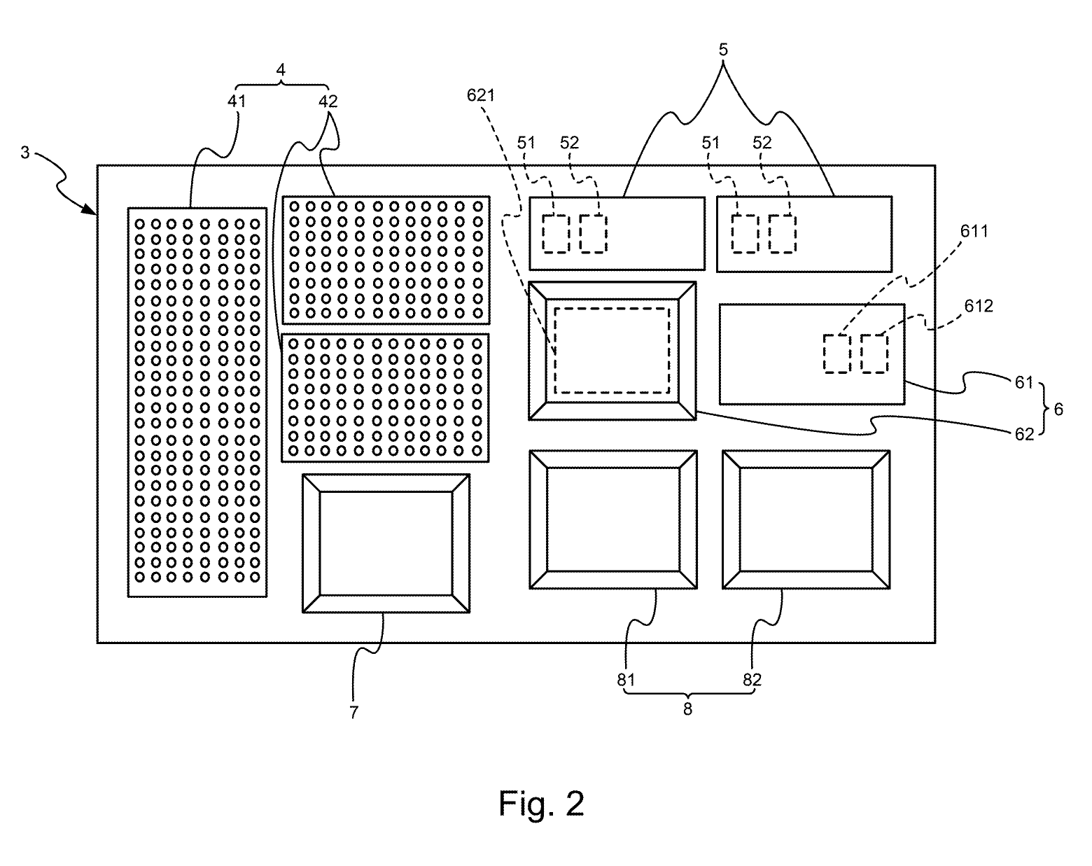

Please refer to FIG. 1 and FIG. 2, which are a perspective view showing a preferred embodiment according to the present invention; and a top-down view showing a carrying platform. As shown in the figures, the present invention is an automated apparatus of screening disease/cancer in vitro, comprising a filling device 1, a gripping device 2, a carrying platform 3, a containing device 4, at least two receiving slots 5, a placing device 6, a shaking device 7 and a detecting device 8.

The filling device 1 comprises at least a first filling unit 11 and a second filling unit 12. Therein, the first filling unit 11 has four dispensers 111, and the second filling unit 12 has at least ninety six dispensers 121. Each dispenser 111, 121 is inserted with tip to be expanded or contracted to different height and/or width for drawing or discharging liquid. Furthermore, the dispensers 111, 121 breaks up samples in wells.

The gripping device 2 is set in the filling device 1. The gripping device 2 is an automatic robotic arm for rotating switches and caps and moving items.

The carrying platform 3 is correspondingly set under the filling device 1 and the gripping device 2.

The containing device 4 is set on the carrying platform 3 and comprises a first containing 41 and a second containing unit 42 for placing small volume containers, like tube racks, 96-well eppendorf, small frozen tubes, tip boxes, etc.

Every receiving slot 5 is set on the carrying platform 3 for placing drugs. Each receiving slot 5 comprises a temperature controller 51 and a shaking unit 52. The temperature controller 51 controls a temperature between −20 celsius degrees (° C.) and 100° C.

The placing device 6 is set on the carrying platform 3 and comprises a first placing unit 61 and a second placing unit 62. Therein, the first placing unit 61 comprises a temperature controller 612 and a shaking unit 611; the temperature control 611 controls a temperature between −20° C. and 100° C.; and, the second placing unit 62 is set with a magnetic adhering part 621 at bottom for adhering magnetic material

The shaking device 7 is set on the carrying platform 3 and is an ultrasonic oscillator to uniformly disperse samples.

The detecting device 8 is set on the carrying platform 3 and comprises a first detecting unit 81 and a second detecting unit 82. Therein the first detecting unit 81 detects luminescence and continuous wavelength absorbance; and, the second detecting unit 82 detects γ-ray.

The present invention provides an apparatus to automatically screen disease/cancer in vitro for molecular biology researches, biochemistry examinations, radioimmunoassay and drug developments. On using the present invention, a sucking volume and an injecting volume are decided at first. The first filling unit 11 or the second filling unit 12 of the filling device 1 is selected for suction. The gripping device 2 opens the receiving slot 5 which stores a medicine. The selected first or second filling unit 11, 12 sucks the medicine stored in the receiving slot 5. Then, the medicine is injected into the second containing unit 42 for drug mixture and reaction. In the mean time, a tube rack (not shown in the figures) of the first containing unit 41 or a 96-well eppendorf (not shown in the figures) of the second filling unit 12 is gripped by the gripping device 2 to be moved to the first placing unit 61 or the second placing unit 62 of the placing device 6. A thermostatic reaction is processed under a shaking environment (and the magnetic adhering part 621 of the second placing unit 62 is adhered with a magnetic material.) Then, the gripping device 2 is used for picking up to move to the shaking device 7, the first detecting unit 81 and the second detecting unit 82 for radioimmunoassay, continuous wavelength absorbance detection and luminescence detection. Thus, on operating experiments, human burden is reduced, operating time is saved, experimental errors are avoided and experimental accuracy and efficiency are enhanced.

To sum up, the present invention is an automatic apparatus of screening disease/cancer in vitro, where an automatic apparatus of screening disease/cancer is provided for molecular biological researches, biochemical examinations, radioimmunoassay and drug developments with reduced human labor, saved operating time, avoided experimental errors and enhanced experimental accuracy and efficiency.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An automatic apparatus of screening disease/cancer in vitro, comprising
a filling device;
a gripping device, said gripping device being located at a side of said filling device;
a carrying platform, said carrying platform being correspondingly located under said filling device and said gripping device;
a containing device, said containing device being located on said carrying platform;
at least two receiving slots, said receiving slots being located on said carrying platform;
a placing device, said placing device being located on said carrying platform;
a shaking device, said shaking device being located on said carrying platform; and
a detecting device, said detecting device being located on said carrying platform.

2. The automatic apparatus according to claim 1,
wherein said filling device comprises a first filling unit and a second filling unit.

3. The automatic apparatus according to claim 2,
wherein said first filling unit comprises four dispensers.

4. The automatic apparatus according to claim 2,
wherein said second filling unit comprises ninety six dispensers.

5. The automatic apparatus according to claim 1,
wherein said gripping device is an automatic robotic arm.

6. The automatic apparatus according to claim 1,
wherein said containing device comprises a first containing unit and a second containing unit.

7. The automatic apparatus according to claim 1,
wherein each of said receiving slots comprises a temperature controller and a shaking unit; and said temperature controller controls a temperature between −20 celsius degrees (° C.) and 100° C.

8. The automatic apparatus according to claim 1,
wherein said placing device comprises a first placing unit and a second placing unit.

9. The automatic apparatus according to claim 8,
wherein said first placing unit comprises a temperature controller and a shaking unit, and said temperature controller controls a temperature between −20° C. and 100° C.

10. The automatic apparatus according to claim 8,
wherein said second placing unit has a magnetic adhering part at bottom.

11. The automatic apparatus according to claim 1,
wherein said shaking device is an ultrasonic oscillator.

12. The automatic apparatus according to claim 1,
wherein said detecting device comprises a first detecting unit and a second detecting unit.

13. The automatic apparatus according to claim 12,
wherein said first detecting unit detects luminescence and continuous wavelength absorbance.

14. The automatic apparatus according to claim 12,
wherein said second detecting unit detects γ-ray.
